(19) United States
(12) Patent Application Publication
(10) Pub. No.: US 2026/0278294 A1
(43) Pub. Date: Sep. 17, 2026

(54) INFORMATION PROCESSING DEVICE, METHOD AND NON-TRANSITORY RECORDING MEDIUM FOR WORK SUPPORT

(71) Applicant: NEC Corporation, Tokyo (JP)

(72) Inventors: Hisaya WAKAYAMA, Tokyo (JP); Shin Norieda, Tokyo (JP); Kenichi Takiguchi, Tokyo (JP); Chisho Ueda, Tokyo (JP); Yuto Tsukada, Tokyo (JP)

(73) Assignee: NEC Corporation, Tokyo (JP)

(21) Appl. No.: 19/556,039

(22) Filed: Mar. 4, 2026

(30) Foreign Application Priority Data
Mar. 14, 2025 (JP) 2025-041813

(51) Int. Cl. G06F 40/40

(52) U.S. Cl. CPC G06F 40/40

(57) ABSTRACT

The information processing device acquires work-related information related to work performed using a plurality of applications. The information processing device determines a tool available for the work based on the work-related information. The information processing device presents the determined tool. According to this information processing device, it is also possible to optimize a work performed using a plurality of applications.

### INCORPORATION BY REFERENCE

This application is based upon and claims the benefit of priority from Japanese patent application No. 2025-41813, filed on Mar. 14, 2025, the disclosure of which is incorporated herein in its entirety by reference.

### TECHNICAL FIELD

The present disclosure relates to a technique for work support.

### BACKGROUND ART

Various application programs (hereinafter, the application may be abbreviated as applications or apps) are used for work using a computer. In addition, a program for work support called “tool” may be used for work using the app. By using the tool, the work using the app can be made efficient. For example, JP 2014-115806 A discloses a work automation support system capable of creating a work automation tool for performing a typical software work.

### SUMMARY

The work automation support system described in JP 2014-115806 A has room for improvement in that an example object of efficiency improvement is limited to a fixed work using browser software and spreadsheet software. Therefore, in order to improve the efficiency of work using another app by using a tool, it is necessary to consider which tool among existing tools is effective according to a combination of apps to be used, a product to be created, and the like. However, performing such examination work itself may lead to inefficiency of the entire work.

The present disclosure has been made in view of the above problems, and an exemplary object of the present disclosure is to provide a technique capable of improving efficiency of work performed using a plurality of applications.

An information processing device according to an example aspect of the present disclosure comprises
at least one memory configured to store instructions, and
at least one processor configured to execute the instructions to
acquire work-related information related to a work performed using a plurality of applications,
determine a tool available for the work based on the work-related information, and
present the determined tool.

A computer implemented method for work support according to an example aspect of the present disclosure comprises
an acquisition process of acquiring work-related information related to a work performed using a plurality of applications,
a tool determination process of determining a tool available for the work based on the work-related information, and
a presentation control process of presenting the determined tool.

A non-transitory recording medium according to an example aspect of the present disclosure stores a work support program. The program causes a computer to execute
an acquisition process of acquiring work-related information related to a work performed using a plurality of applications,
a tool determination process of determining a tool available for the work based on the work-related information, and
a presentation control process of presenting the determined tool.

According to an example aspect of the present disclosure, there is an exemplary effect that it is possible to provide a technique capable of improving efficiency of work performed using a plurality of applications.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of a work support method according to the present disclosure;

FIG. 3 is a block diagram illustrating a configuration of another information processing device according to the present disclosure;

FIG. 4 is a diagram illustrating an example of tool information used for determining a tool;

FIG. 5 is a diagram illustrating an example in which a tool to be recommended is determined using a language model;

FIG. 6 is a diagram illustrating a presentation example of a tool;

FIG. 7 is a diagram illustrating another presentation example of the tool;

FIG. 8 is a diagram illustrating still another presentation example of the tool;

FIG. 9 is a flowchart illustrating a flow of processing executed by the information processing device illustrated in FIG. 3; and

FIG. 10 is a block diagram illustrating a configuration of a computer that functions as the information processing device according to the present disclosure.

### EXAMPLE EMBODIMENTS

Hereinafter, example embodiments of the present disclosure will be exemplified. However, the present disclosure is not limited to each of the following exemplary example embodiments, and various modifications may be made within the scope described in the claims. For example, example embodiments obtained by appropriately combining techniques (some or all of objects or methods) used in each of the following exemplary example embodiments may fall within the scope of the present disclosure. Example embodiments obtained by appropriately omitting some of the techniques adopted in each of the following exemplary example embodiments may fall within the scope of the present disclosure. Effects mentioned in each of the following exemplary example embodiments are examples of effects expected in the exemplary example embodiment, and do not define extension of the present disclosure. That is, example embodiments that do not exert the effects mentioned in each of the following exemplary example embodiments may also fall within the scope of the present disclosure.

### First Exemplary Example Embodiment

A first exemplary example embodiment, that is an example of the example embodiments of the present disclosure, is described in detail with reference to the drawings. The present exemplary example embodiment is a basic form of each of the exemplary example embodiments described later. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment can also be adopted in another exemplary example embodiment included in the present disclosure within a range in which no particular technical problem occurs.

### Configuration of Information Processing Device 1

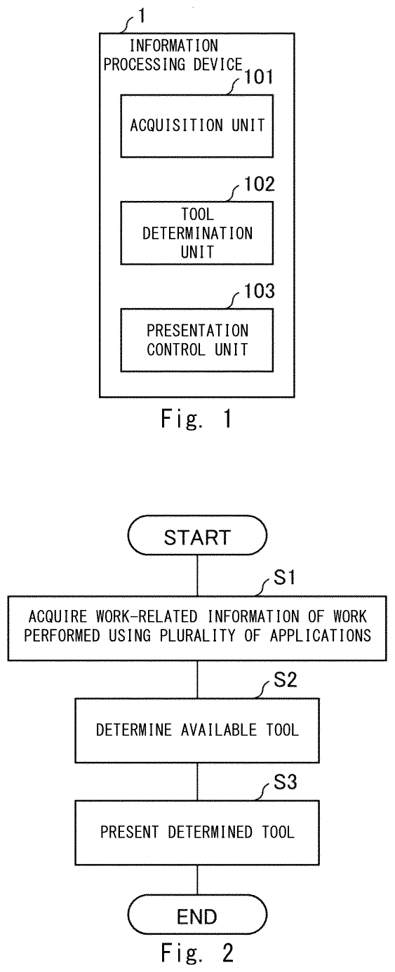

A configuration of an information processing device 1 according to the present exemplary example embodiment is described with reference to FIG. 1. FIG. 1 is a block diagram illustrating the configuration of the information processing device 1. As illustrated in FIG. 1, the information processing device 1 includes an acquisition unit 101, a tool determination unit 102, and a presentation control unit 103.

The acquisition unit 101 acquires work-related information related to work performed using a plurality of applications. Here, the “application” is software designed for executing a predetermined task or implementing a predetermined function. It can be said that this “application” is software specialized for individual purposes. The “application” can be rephrased as application software or an application program, or can be abbreviated as an “app”, “software”, or the like.

Hereinafter, the work may be referred to as “target work”, and the application may be referred to as “target app”. “Target work” is work performed using a plurality of target apps. For example, it is assumed that the worker performs an operation of copying an image created by the image editing app and pasting the image on a slide created by the presentation application for creating presentation material. In this case, the acquisition unit 101 may acquire the work-related information related to the work with the work of performing the copy operation and the paste operation as the target work. In this case, the image editing app and the presentation application are the target apps.

The “work-related information” may be information related to the target work and may include information that serves as a determination material in the case of determining a tool available in a case where the target work is performed. For example, the work-related information may include any one or both of history information indicating a history of operations by a worker who has performed the target work and identification information of each target app used for the target work. In a case where there is a product generated by the target work, information indicating the product can be used as the work-related information. For example, in a case where the target work is a work of performing the above-described copy/paste operation, the acquisition unit 101 may acquire information indicating the content (create and save an image using the image editing app, copy the saved image, paste the copied image on a slide of the presentation application, and the like) of the job as the work-related information. In addition, for example, a work log or the like recorded with respect to the content of the target work can be used as the work-related information. The work log can be recorded by, for example, a predetermined application program.

Any method of acquiring the work-related information may be employed. For example, the acquisition unit 101 may acquire the work-related information from another device (for example, a computer used for work using the app described above) by communication, or may acquire the work-related information input to the information processing device 1. In a case where the target work is performed using the information processing device 1, the acquisition unit 101 may generate information indicating the content of the operation performed on the information processing device 1 and acquire the generated information as the work-related information. The “computer” can also be referred to as a terminal device, an information processing device, a processor, or the like.

The tool determination unit 102 determines a tool available for the target work based on the work-related information acquired by the acquisition unit 101. The tool determined by the tool determination unit 102 is a tool that the information processing device 1 recommends to be used by the worker of the target work. It can also be said that the tool determined by the tool determination unit 102 is a tool for improving the efficiency or automating the target work.

Here, the “tool” is a program for supporting work using an app. Both the application used for the target work and the tool determined by the tool determination unit 102 are computer programs in common. Therefore, the tool determined by the tool determination unit 102 can also be referred to as application software or an application program, or can be abbreviated as “app”, “software”, or the like.

The tool determination unit 102 may determine a tool available for the target work from among various existing efficiency improvement tools and automation tools. The existing efficiency improvement tool also includes a machine-learned model such as a large language model (LLM). The tool determination unit 102 may specify a recommended tool by a function. For example, the tool determination unit 102 may determine “a tool for extracting a difference between two text documents”, “a tool for automatically arranging objects in a presentation”, or the like as a tool available for the target work.

Determining the tool “based on the work-related information” means directly or indirectly using the work-related information in determining the tool. For example, even in a case where a tool is determined using information obtained by analyzing the work-related information, it can be said that the tool is determined “based on the work-related information”.

The presentation control unit 103 presents the tool determined by the tool determination unit 102. Any mode of tools is applicable. For example, the presentation control unit 103 may present the tool in a mode of causing a display device to display and output characters, images, and the like indicating the tool determined by the tool determination unit 102, causing a sound output device to output the characters by sound, or causing a printing device to print and output the characters, images, and the like. The presentation target of the tool is arbitrary. For example, the presentation target of the tool may be a worker, may be another person who performs similar work, or may be an administrator or the like who considers improving the efficiency of the target work.

As described above, the information processing device 1 according to the present exemplary example embodiment employs a configuration including the acquisition unit 101 that acquires the work-related information related to a work performed using a plurality of applications, the tool determination unit 102 that determines a tool available for the work based on the work-related information, and the presentation control unit 103 that presents the determined tool.

According to the above configuration, it is possible to present the tool available for the work to the worker or the like who has performed the work using the plurality of applications. Therefore, by using the presented tool, the worker or the like can perform the work more efficiently than the previous work in the case of performing the work using the plurality of applications thereafter. As described above, according to the information processing device 1, it is possible to improve the efficiency of work performed using a plurality of applications. According to the information processing device 1, it is also possible to optimize work performed using a plurality of applications.

### Work Support Program

The functions of the information processing device 1 described above can also be achieved by a program. A work support program according to the present exemplary example embodiment causes a computer to function as: an acquisition means for acquiring work-related information related to work performed using a plurality of applications; a tool determination means for determining a tool available for the work based on the work-related information; and a presentation control means for presenting the determined tool. According to this work support program, it is possible to improve the efficiency of work performed using a plurality of applications.

### Flow of Work Support Method

A flow of a work support method according to the present exemplary example embodiment will be described with reference to FIG. 2. FIG. 2 is a flowchart illustrating a flow of the work support method. An executing entity of each step in the work support method may be a processor included in the information processing device 1, may be a processor included in another device, or an executing entity of each step may be a processor provided in each of different devices.

In S1 (acquisition process), at least one processor acquires work-related information related to work performed using a plurality of applications.

In S2 (tool determination process), at least one processor determines a tool available for the work based on the work-related information acquired in S1.

In S3 (presentation control process), at least one processor presents the tool determined in S2.

As described above, in the work support method according to the present exemplary example embodiment, a configuration is adopted in which at least one processor executes an acquisition process of acquiring work-related information related to work performed using a plurality of applications, a tool determination process of determining a tool available for the work based on the acquired work-related information, and a presentation control process of presenting the determined tool. According to this work support method, it is possible to improve efficiency of work performed using a plurality of applications.

### Second Exemplary Example Embodiment

A second exemplary example embodiment, that is an example of the example embodiments of the present disclosure, is described in detail with reference to the drawings. Components having the same functions as the components described in the exemplary example embodiment described above are denoted by the same reference numerals, and descriptions thereof will be omitted as appropriate. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information Processing Device 1A

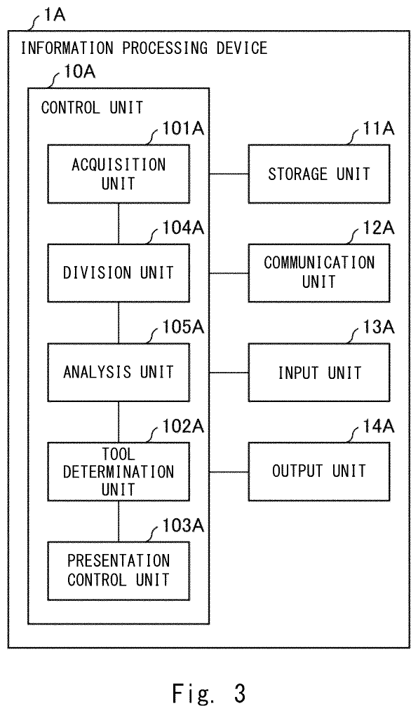

A configuration of an information processing device 1A according to the present exemplary example embodiment is described with reference to FIG. 3. FIG. 3 is a block diagram illustrating the configuration of the information processing device 1A. The information processing device 1A is a device having a function of supporting work performed using an app. The information processing device 1A may be a local device (for example, a device used by a worker who performs the target work) used by individual users, or may be a server that provides work support services to a plurality of users.

As illustrated, the information processing device 1A includes a control unit 10A that integrally controls units of the information processing device 1A and a storage unit 11A that stores various types of data to be used by the information processing device 1A. The information processing device 1A includes a communication unit 12A for the information processing device 1A to communicate with another device, an input unit 13A for receiving an input to the information processing device 1A, and an output unit 14A for the information processing device 1A to output data. Then, the control unit 10A includes an acquisition unit 101A, a tool determination unit 102A, a presentation control unit 103A, a division unit 104A, and an analysis unit 105A.

Similarly to the acquisition unit 101 of the first exemplary example embodiment, the acquisition unit 101A acquires the work-related information related to the target work performed using the plurality of target apps. The method of acquiring the work-related information is arbitrary as in the first exemplary example embodiment. For example, the acquisition unit 101A may acquire the work-related information from a computer used by a worker who has performed a target work using a plurality of target apps for the target work through communication via the communication unit 12A.

The division unit 104A divides a series of works performed by the worker into a plurality of partial works based on the work-related information acquired by the acquisition unit 101A. In a case where the division unit 104A divides the work into a plurality of partial works, the partial works are target works that are targets for determining a tool recommended by each partial work. That is, the tool determination unit 102A determines a tool available for each of a plurality of partial works. As a result, in addition to the effects obtained by the information processing device 1, it is possible to obtain an effect that the work can be made efficient in units of partial works. A specific classification method of the target work will be described later.

The analysis unit 105A analyzes the work-related information acquired by the acquisition unit 101A. The analysis result by the analysis unit 105A is used for determination of a tool by the tool determination unit 102A. An analysis method applied by the analysis unit 105A will be described later.

Similarly to the tool determination unit 102 of the first exemplary example embodiment, the tool determination unit 102A determines a tool available for the target work based on the work-related information acquired by the acquisition unit 101A. More specifically, the tool determination unit 102A determines a tool using an analysis result obtained by analyzing the work-related information by the analysis unit 105A.

Similarly to the presentation control unit 103 of the first exemplary example embodiment, the presentation control unit 103A presents the tool determined by the tool determination unit 102A. As in the first exemplary example embodiment, the tool presentation method is arbitrary. For example, the presentation control unit 103A may present the tool by causing a display device connected to a computer used by the worker for the target work to display and output a sentence indicating the tool determined by the tool determination unit 102A.

### Method of Dividing Target Work

As described above, the division unit 104A divides a series of works performed by the subject into a plurality of partial works based on the work-related information acquired by the acquisition unit 101A. The classification method of the target work may be any method as long as the work can be classified in units in which the relevant tool can exist.

For example, in a case where the execution period of the series of works includes a period in which the operation by the worker is not performed for a predetermined time or more, the division unit 104A may divide the work by the period. For example, the division unit 104A may divide a series of works into a plurality of partial works by detecting that the worker has performed an operation of switching an app to be a work target and dividing the series of works at each time in a case where the operation is detected. For example, the division unit 104A may detect a predetermined operation performed for each work section from the history of the input operation of the worker in the execution period. Then, the division unit 104A may break the series of works into a plurality of partial works by dividing the series of works at each time at which the predetermined operation is detected. What kind of operation to set the predetermined operation as may be defined in advance. For example, in a case where the worker performs a series of works of editing electronic data, the division unit 104A may detect an operation of storing the electronic data as the predetermined operation.

### Method for Analyzing Work-Related Information

As described above, the analysis unit 105A analyzes the work-related information acquired by the acquisition unit 101A. The analysis method applied by the analysis unit 105A may be any method as long as an analysis result useful for determining a tool by the tool determination unit 102A can be obtained. In other words, in a case where the tool determination method by the tool determination unit 102A is determined, it is determined by which analysis method the analysis unit 105A should output what analysis result.

For example, the analysis unit 105A may estimate a relationship between a plurality of target apps in the target work, in other words, a role or a function of each target app in performing the target work, from the work-related information. In this case, the tool determination unit 102A determines a tool relevant to the relationship estimated by the analysis unit 105A as a tool available for the target work. As a result, in addition to the effect obtained by the information processing device 1, an effect that an appropriate tool can be determined according to the relationship between the target apps, in other words, the mode of cooperation between the target apps can be obtained.

The relationship between the target apps may be classified in advance. For the relationship of each classification, a relevant tool may be determined in advance. In this case, the analysis unit 105A may infer which type of relationship is relevant to the work-related information. Then, the tool determination unit 102A can determine a tool based on the result of the inference.

For example, the analysis unit 105A may estimate whether a plurality of target apps has a relationship of exchanging data in the target work. Then, in a case where it is estimated that a plurality of target apps have a relationship of exchanging data in the target work, the tool determination unit 102A may determine a tool that automates or facilitates at least a part of the work performed by the worker for exchanging the data as a tool available for the target work.

As a result, in addition to the effect obtained by the information processing device 1, it is possible to achieve an effect of automating or facilitating at least a part of the work performed by the worker to exchange data between the target apps.

For example, the analysis unit 105A may estimate whether there is a relationship of using data held or generated by at least another one target app in generating a product by one of the plurality of target apps. Then, in a case where it is estimated that there is a relationship of using data held or generated by at least another one target app in generating a product by one target app, the tool determination unit 102A may determine a tool that automates or facilitates at least a part of work performed by the worker to generate the product as a tool available for the target work.

As a result, in addition to the effect obtained by the information processing device 1, it is possible to achieve an effect of automating or facilitating at least a part of the work performed by the worker to generate the product using the target app. A relationship in which data held or generated by at least another one target app is used to generate a product by one of the plurality of target apps is included in a category of a relationship in which data is exchanged between the target apps, and the target app on the data receiving side is limited to use the data to generate a product. By using such a more detailed analysis result, a more appropriate tool can be recommended.

For example, the analysis unit 105A may estimate the content of the target work from the work-related information. For example, it is assumed that the work-related information indicates that, after a copy operation is performed on an image editing app which is one of the target apps, a paste operation is performed on a presentation application which is another one of the target apps. In this case, the analysis unit 105A can estimate that the content of the target work is content of creating a presentation using the created image. For example, if a combination of various operations and the content of the work in a case where the operation related to the combination is performed are associated in advance, such estimation can be performed using association information indicating the association.

The analysis unit 105A can also estimate the content of the target work using, for example, a language model in which the natural language has been machine-learned. In this case, the analysis unit 105A may generate a prompt that includes the work-related information and instructs to estimate the content of the target work from the work-related information, and input the generated prompt to the language model. As a result, the estimation result of the content of the target work is output from the language model.

Here, machine learning on natural language more specifically means learning of the arrangement of constituent elements (words etc.) in a sentence of a natural language and the arrangement of a sentence and a sentence in a writing. Examples of the language model trained on natural language include bidirectional encoder representations from transformers (BERT), robustly optimized BERT approach (RoBERTa), efficiently learning an encoder that classifies token replacements accurately (ELECTRA), and the like.

In a case where it is unclear what kind of app the target app is, the analysis unit 105A may estimate what kind of app the target app is from the work-related information. For example, in a case where the work-related information includes information indicating a file format of a product created by the target work, the analysis unit 105A may estimate that an app capable of generating a file of the file format is the target app. The analysis unit 105A can also estimate what kind of app the target app is using the language model described above.

The analysis unit 105A may analyze the work-related information and perform a process of detecting the target work from the work performed by the worker. For example, in a case where the division unit 104A divides a series of works by the worker into a plurality of partial works, there is a possibility that the partial works include works performed using a plurality of target apps and works performed using a single target app. Therefore, the analysis unit 105A may detect a work performed using a plurality of target apps among a plurality of partial works defined by the division unit 104A as the target work.

A method for detecting the target work is not particularly limited. For example, it is assumed that the work-related information is history information indicating an operation performed by a worker and an app that is a target of the operation. In this case, the analysis unit 105A may detect, from the history information, an event in which an operation for another app is performed immediately after an operation for a certain app is performed, and may detect a work including these operations as the target work.

### Tool Determination Method 1: Using Tool Information

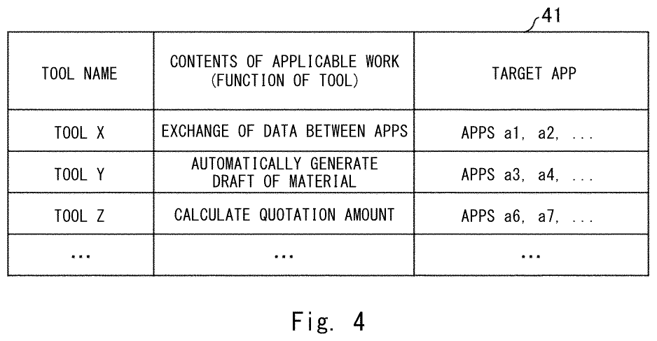

A method of determining a tool by the tool determination unit 102A will be described with reference to FIG. 4. FIG. 4 is a diagram illustrating an example of tool information used for determining a tool. Tool information 41 illustrated in FIG. 4 is tabular data indicating the function of each candidate of the recommended tool. The tool information 41 may be stored in the storage unit 11A or may be stored in a storage device outside the information processing device 1A.

The tool information 41 lists a plurality of tools such as a tool X, a tool Y, and a tool Z. These tools are candidates for tools recommended to the worker for improving the efficiency of the target work. In the tool information 41, for each of the listed tools, information indicating the content of work to which the tool is applicable, in other words, the function of the tool, and information indicating an app to which the tool is applicable are associated with each other. As a result, the tool determination unit 102A refers to the tool information 41 and can determine a tool relevant to the content of the target work and the target app used for the target work as a tool available for the target work.

In a case where the tool determination unit 102A determines a tool available for the target work using the tool information 41, the analysis unit 105A may estimate at least one of the content of the target work and the target app by analyzing the work-related information. Therefore, in this case, the acquisition unit 101A may acquire at least one of the information necessary for estimating the content of the target work and the information necessary for estimating the target app as the work-related information.

For example, it is assumed that the acquisition unit 101A acquires work-related information indicating the content of an operation (for example, a copy operation or the like) performed by the worker and a target app that is a target of the operation. In this case, the analysis unit 105A can estimate the combination of the target apps used for the target work from the work-related information, and can estimate the content of the target work from the work-related information.

The function necessary for improving the efficiency of the target work may be defined in advance for each combination of operation contents for each target app. For example, it may be defined in advance that a copy/paste operation between apps is an operation for exchanging data between apps. In this case, if the work-related information indicates that the paste operation is performed on an app a2 after the copy operation on an app a1, the analysis unit 105A can estimate that the content of the target work is data exchange between apps based on the above regulation. The analysis unit 105A can also estimate the content of the target work and the target app using a language model or the like.

As described above, the analysis unit 105A may estimate the content of the target work based on the work-related information. Then, the tool determination unit 102A may determine a tool available for the work of the content estimated by the analysis unit 105A using the tool information 41 indicating the function of each candidate of the recommended tool. As a result, in addition to the effect obtained by the information processing device 1, an effect that a tool suitable for the content of the target work can be recommended to the worker can be obtained.

In the work to which each tool can be applied, information indicating a relationship between a plurality of apps used for the work (for example, “a relationship of exchanging data between apps”) may be included in the tool information 41. In this case, if the analysis unit 105A is caused to estimate the relationship between the target apps in the target work, the tool determination unit 102A can specify a tool relevant to the estimation result from the tool information 41.

### Tool Determination Method 2: Using Language Model

The tool determination unit 102A can determine a tool relevant to the work-related information using a language model in which the natural language has been machine-learned. As a result, an effect that a tool suitable for the content of the target work can be recommended to the worker from the work-related information described in the natural language (or the analysis result of the work-related information) can be obtained. In a case where the language model is used, the analysis by the analysis unit 105A can be omitted.

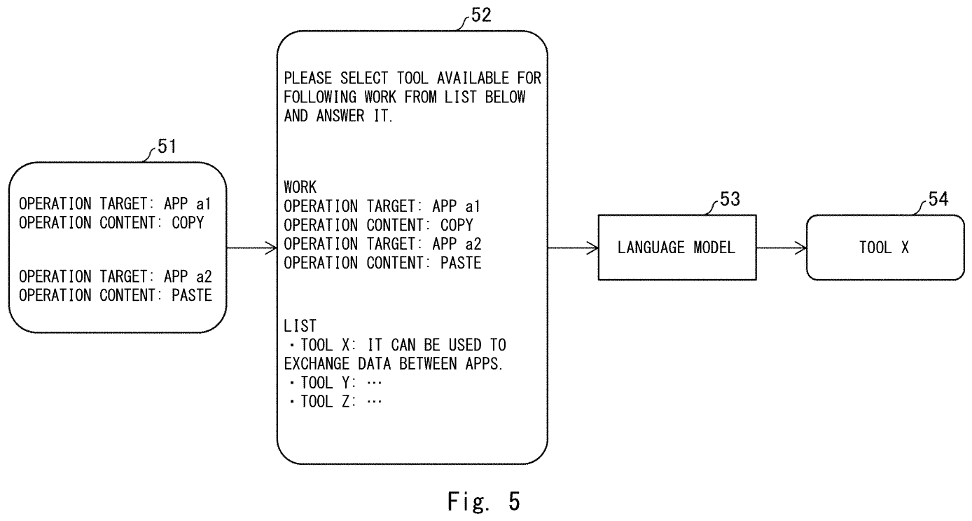

FIG. 5 is a diagram illustrating an example in which a tool to be recommended is determined using a language model. In the example of FIG. 5, work-related information 51 indicating the target app that is the operation target of the worker in the target work and the operation content for the target app is used. Then, a prompt 52 is generated from the work-related information 51, the generated prompt 52 is input to a language model 53 that has learned the natural language, and an answer 54 indicating that “tool X” is the recommended tool is output from the language model 53.

The prompt 52 is a prompt for instructing to infer a tool that can make the target work efficient, and is generated by the tool determination unit 102A using the work-related information 51. Since the portion other than “work” in the prompt 52 is a fixed form, if the portion other than “work” is templated, the tool determination unit 102A can generate the prompt 52 using the template and the work-related information 51.

The prompt 52 includes a “list” indicating each candidate of a recommended tool, and instructs to select a tool from the list to answer. Description of each tool is described in this list. As a result, since the language model 53 can infer a tool to be recommended with reference to the description, it is possible to recommend a tool that the language model 53 has not learned. It is not essential to include a list in the prompt, but including a list can reduce the possibility that recommended tools diverge or invalid tools are recommended. Instead of including the list in the prompt, the language model 53 may refer to the list recorded in an external database or the like. The list can be referred to by the language model 53 using a technology such as retrieval-augmented generation (RAG).

Also in a case where a tool to be recommended is determined using the language model 53, the analysis unit 105A may be caused to perform analysis. In this case, the tool determination unit 102A may use the analysis result of the analysis unit 105A to generate a prompt for instructing to infer a tool capable of improving the efficiency of the target work based on the analysis result.

### Tool Presentation Example 1

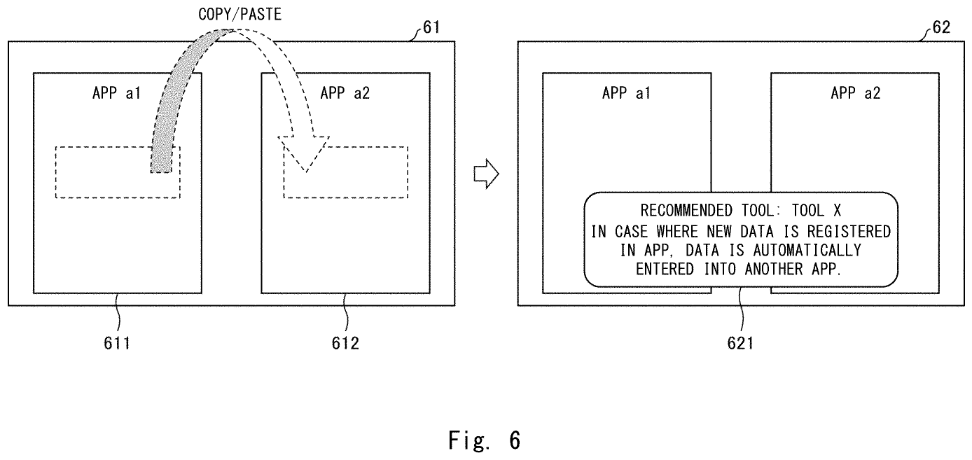

FIG. 6 is a diagram illustrating a presentation example of a tool by the information processing device 1A. FIG. 6 illustrates a screen example 61 which is an example of a display screen in a case where the worker performs the target work and a screen example 62 which is an example of a display screen in a case where a tool available for the target work is recommended. Such a display screen is displayed on, for example, a display device connected to a computer used by the worker for the target work under the control of the presentation control unit 103A.

In the screen example 61, a window 611 displayed by the app a1 which is one of the target apps and a window 612 displayed by the app a2 which is another one of the target apps are displayed. Then, as indicated by a broken line in the screen example 61, in the example of FIG. 6, work (target work) of copying a part of the data displayed in the window 611 and pasting the copied data on the data displayed in the window 612 is performed. Although not illustrated in FIG. 6, the work-related information related to the target work is acquired by the acquisition unit 101A, and a recommended tool is determined based on the work-related information.

In the example of FIG. 6, after the target work is performed, the presentation control unit 103A displays a notification message 621 as illustrated in the screen example 62. The notification message 621 indicates a recommended tool and a function of the tool. By displaying the notification message 621, the worker can recognize a tool available for the target work previously performed, and use the tool to make subsequent similar jobs efficient.

Timing of acquiring the work-related information and timing of presenting the tool are arbitrary. For example, the work-related information may be acquired as needed, whether the target work is performed may be monitored, and the tool may be determined and presented in a case where the target work is detected. In this case, it is possible to present a recommended tool during a period in which the worker performs a series of works including the target work. Thus, for example, in a case where the worker repeatedly performs the same target work, the second and subsequent target works can be made more efficient by the tool.

For example, the work-related information may be acquired after a series of works of the worker is completed. In this case, since the obtained work-related information includes information regarding a series of works, the works may be classified by the division unit 104A. Instead of performing the division by the division unit 104A, the analysis unit 105A may be caused to extract a target work among a series of works.

In the case of the example of FIG. 6, the acquisition unit 101A may acquire history information of a series of operations by the worker including the illustrated copy/paste operation as the work-related information. Then, the division unit 104A may divide a series of works by the worker into a plurality of partial works using the acquired history information. The analysis unit 105A may set a work performed using a plurality of target apps among a plurality of partial works defined by the division unit 104A as the target work. Since the above-described copy/paste operation is performed using the two target apps of the app a1 and the app a2, this work by the subject is identified as the target work.

Since a copy operation is performed on the app a1 and a paste operation is performed on the app a2 in the target work, the analysis unit 105A estimates that data is exchanged between the apps. As a result, the tool determination unit 102A can determine the “tool X” applicable to data exchange between apps as a tool applicable to the target work, for example, with reference to the tool information 41 in FIG. 4. As described above, a recommended tool can be determined based on the analysis result of the relationship between the target apps, or a recommended tool can be determined using the language model 53.

Timing of acquiring the work-related information and timing of presenting the tool are arbitrary. For example, a series of processes from acquisition of the work-related information to presentation of the tool may be performed immediately after the target work is performed. In this case, it is possible to present a recommended tool during a period in which the worker performs a series of works including the target work. Thus, for example, in a case where the worker repeatedly performs the same target work, the second and subsequent target works can be made more efficient by the tool.

For example, the work-related information may be acquired after a series of works of the worker is completed. In this case, since the obtained work-related information includes information regarding a series of works, the works may be classified by the division unit 104A. Instead of performing the division by the division unit 104A, the analysis unit 105A may be caused to extract a target work among a series of works.

### Tool Presentation Example 2

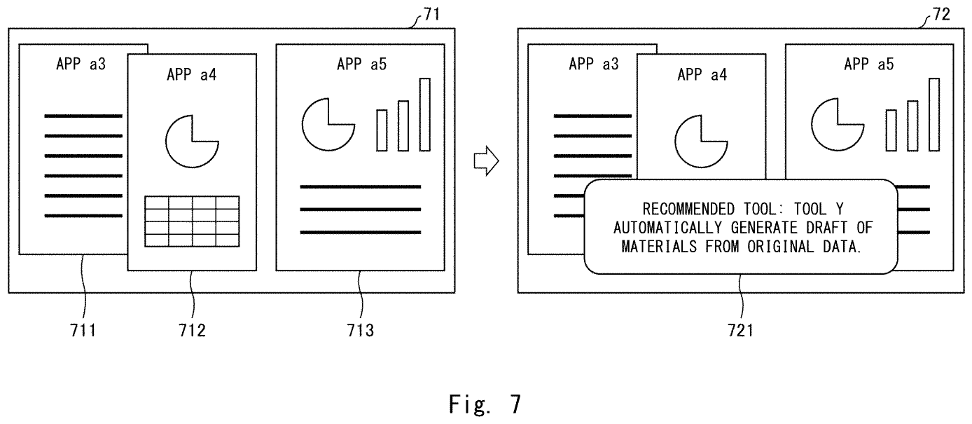

FIG. 7 is a diagram illustrating another presentation example of a tool by the information processing device 1A. FIG. 7 illustrates a screen example 71 which is an example of a display screen in a case where the worker performs the target work and a screen example 72 which is an example of a display screen in a case where a tool available for the target work is recommended.

In the screen example 71, a window 711 displayed by an app a3 which is one of the target apps, a window 712 displayed by an app a4 which is another one of the target apps, and a window 713 displayed by an app a5 which is still another one of the target apps are displayed. In the example of FIG. 7, a work of creating the data displayed in the window 713 is performed while referring to the data displayed in the windows 711 and 712. Then, after this work is performed, as illustrated in the screen example 72, a notification message 721 indicating a recommended tool and a function of the tool is displayed.

As described above, the target work performed by the worker using the plurality of target apps may be work (hereinafter, referred to as reference editing work) of creating or editing data by another app with reference to the data displayed by the target app. As in the example of FIG. 7, in the reference editing work, a plurality of target apps may be caused to display data to be referred to. For a specific work such as the reference editing work, a tool to be recommended may be determined in advance. In this case, the analysis unit 105A may detect the specific work from the work-related information.

For example, the analysis unit 105A can detect that the reference editing work has been performed based on the history information of the operation of the worker. The history information for detecting that the reference editing work has been performed may include a history of various operations generally performed in the reference editing work. For example, the reference editing work can be detected by using history information indicating a history of an operation of starting each target app, an operation of opening a file in each target app, an operation of switching data to be displayed in each target app, an input operation to each target app, and the like.

The tool available for the reference editing work may be registered in the tool information 41 in advance. In this case, in a case where the analysis unit 105A detects that the reference editing work has been performed, the tool determination unit 102A can specify a tool available for the reference editing work with reference to the tool information 41.

### Tool Presentation Example 3

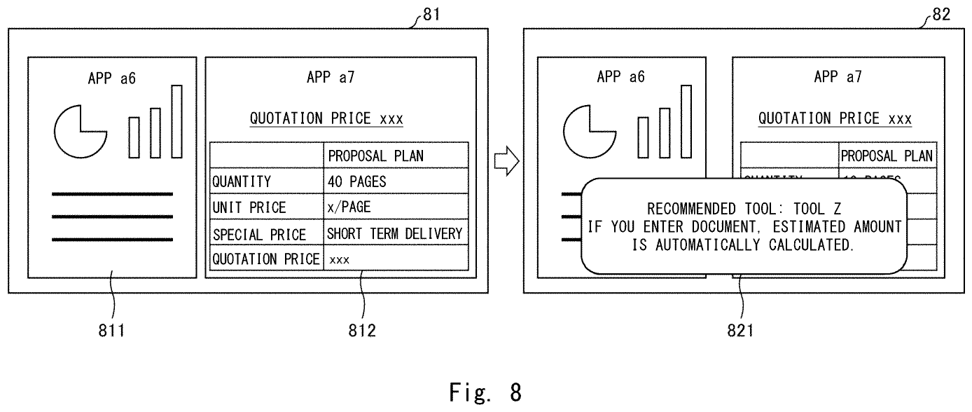

FIG. 8 is a diagram illustrating still another presentation example of a tool by the information processing device 1A. FIG. 8 illustrates a screen example 81 which is an example of a display screen in a case where the worker performs the target work and a screen example 82 which is an example of a display screen in a case where a tool available for the target work is recommended.

In the screen example 81, a window 811 displayed by an app a6 which is one of the target apps and a window 812 displayed by an app a7 which is another one of the target apps are displayed. In the example of FIG. 8, a work of creating data (specifically, an estimate) displayed in a window 813 while referring to the data (specifically, a proposal of a plan to be estimated) displayed in the window 811 is performed. Then, after this work is performed, as illustrated in the screen example 82, a notification message 821 indicating a recommended tool and a function of the tool is displayed.

In the target work in the example of FIG. 8, data is not exchanged between the target apps. Therefore, the target work in the example of FIG. 8 can be said to be the reference editing work similarly to the example of FIG. 7. Therefore, the analysis unit 105A can detect that the reference editing work has been performed similarly to the example of FIG. 7, and the tool determination unit 102A can determine a tool available for the detected reference editing work.

In the example of FIG. 8, if it is found that the product generated by the reference editing work is an estimate, the tool determination unit 102A can also determine a tool that makes creation work of the estimate efficient, such as “tool Z” notified by the notification message 821, as a tool available for the reference editing work. In this case, the analysis unit 105A may estimate the product generated by the reference editing work based on the work-related information.

As described above, the analysis unit 105A may estimate the product created by the target work. Then, the tool determination unit 102A may determine a tool that can be used to create the estimated product as a tool available for the target work.

Similarly, the analysis unit 105A may estimate any one or both of a target app used to create a product and a target app used to output data to be referred to for creating a product. As a result, the tool determination unit 102A can determine a tool that can be used to create a product using the estimated target app as a tool available for the target work. As described above, by causing the analysis unit 105A to perform various analyses, it is possible to recommend a tool relevant to the analysis result.

### Flow of Processing

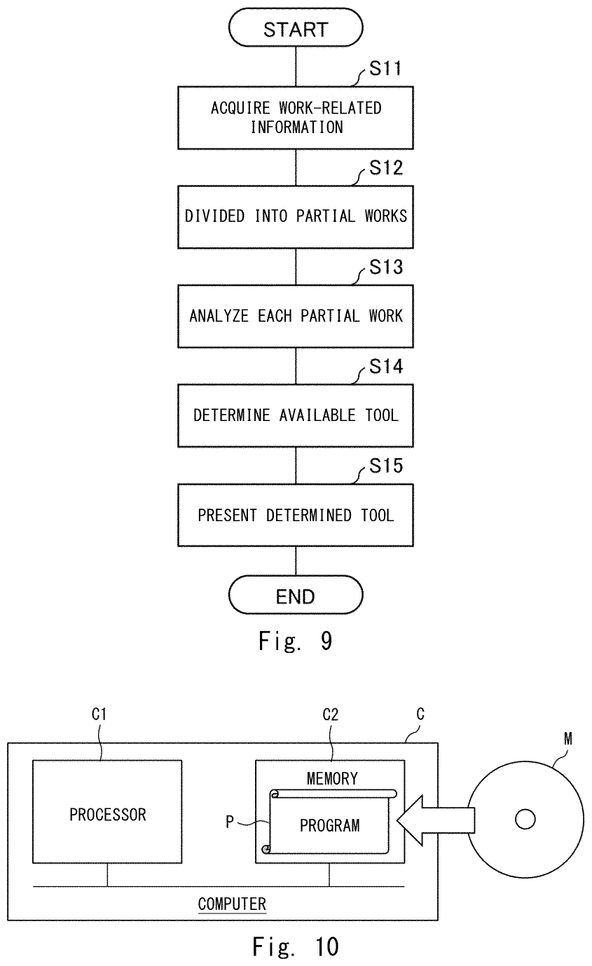

A flow of processing executed by the information processing device 1A will be described with reference to FIG. 9. FIG. 9 is a flowchart illustrating the flow of processing executed by the information processing device 1A. The flowchart of FIG. 9 includes each process of the work support method according to the present exemplary example embodiment.

In S11 (acquisition process), the acquisition unit 101A acquires the work-related information related to the target work performed using the plurality of target apps. For example, in a case where the work by the worker is performed using a computer different from the information processing device 1, the acquisition unit 101A may acquire the work-related information from the computer.

In S12, the division unit 104A divides a series of works performed by the worker into a plurality of partial works based on the work-related information acquired in S11. Here, as described above, the analysis unit 105A may detect a work performed using a plurality of target apps among a plurality of partial works defined by the division unit 104A as the target work. Such processing may not be performed, and each of the plurality of partial works defined by the division unit 104A may be set as the target work as it is. The process of S12 may be omitted, and the process may proceed to the process of S13.

In S13, the analysis unit 105A analyzes the work-related information acquired in S11. The content of the analysis is relevant to the tool determination method in S14. For example, as described above, the tool determination unit 102A may determine the tool available for the target work based on the relationship between the target apps, and in this case, the relationship between the target apps is estimated in S13. The process of S13 is performed for each of the plurality of partial works defined in S12.

In S14 (tool determination process), the tool determination unit 102A determines a tool available for the target work based on the work-related information acquired in S11. More specifically, the tool determination unit 102A determines a tool using the analysis result of S13 for the work-related information acquired in S11. The determination of the tool in S14 is performed for each of the partial works defined in S13.

In S15 (presentation control process), the presentation control unit 103A presents the tool determined in S14. For example, the presentation control unit 103A may present the tool by displaying the name or the like of the tool determined in S14 on a display device connected to the worker's computer. Thereby, the process of FIG. 9 is ended.

As described above, the tool may be presented as needed during a period in which the worker performs a series of works. In this case, the acquisition unit 101A may acquire history information of the operation by the worker as needed, and the analysis unit 105A may detect that the work using the plurality of target apps, that is, the target work is performed from the acquired history information. Then, in a case where the target work is detected, the tool determination unit 102A may determine a tool available for the target work, and the presentation control unit 103A may present the determined tool.

### Modified Examples

In the above-described exemplary example embodiment, an example has been described in which a tool available for a target work performed by using a plurality of target apps in combination in one computer (which may be the information processing device 1 or 1A) is determined and presented. However, the target work is not necessarily performed using one computer (which can also be referred to as a device), and may be performed using a plurality of computers. For example, it is also possible to determine and propose a tool available for a target work with the work performed using an app operating on a portable terminal device such as a smartphone and an app operating on a stationary terminal device such as a PC in combination as the target work. For example, it is also possible to determine and propose a tool available for a target work with the work performed using an app operating on a wearable device that measures biological information such as a heart rate and a blood pressure and an app operating on a portable terminal device such as a smartphone in combination as the target work. In this manner, the information processing devices 1 and 1A can also be used for healthcare applications.

The information processing devices 1 and 1A can also be used to provide an online tool recommendation service, for example. In this case, the information processing devices 1 and 1A collect and accumulate work-related information of each user of the service. Then, the information processing devices 1 and 1A determine a tool available for the work performed by each user based on the accumulated work-related information, and present the determined tool to the user.

An executing entity of each processing described in the above-described exemplary example embodiments is optional, and is not limited to the above-described examples. For example, a system having functions similar to those of the information processing devices 1 and 1A can be constructed by a plurality of devices capable of communicating with each other. The executing entity of each process illustrated in the flowchart of FIG. 9 may be one device (may be rephrased as a processor) or a plurality of devices (may be similarly rephrased as processors).

### Example of Implementation by Software

Some or all of the functions of the information processing devices 1 and 1A (hereinafter, also referred to as “each of the above devices”) may be implemented by hardware such as an integrated circuit (IC chip) or may be implemented by software.

In the latter case, each of the above devices is achieved by, for example, a computer that executes commands of a program that is software for implementing each function. An example of such a computer (hereinafter, referred to as computer C) is illustrated in FIG. 10. FIG. 10 is a block diagram illustrating a hardware configuration of the computer C that functions as each of the above devices.

The computer C includes at least one processor C1 and at least one memory C2. A program (work support program) P for operating the computer C as each of the above devices is recorded in the memory C2. In the computer C, by the processor C1 reading the program P from the memory C2 and executing the program P, each function of each of the above devices is implemented. The program P may be installed in the computer C as a tool recommendation app.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output apparatuses such as a keyboard, a mouse, a display, or a printer.

The program P can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information 1

The present disclosure includes the technologies described in the following Supplementary Notes. However, the present disclosure is not limited to the techniques described in the following Supplementary Notes, and various modifications may be made within the scope described in the claims.

### Supplementary Note A1

An information processing device including: an acquisition means for acquiring work-related information related to a work performed using a plurality of applications; a tool determination means for determining a tool available for the work based on the work-related information; and a presentation control means for presenting the determined tool.

### Supplementary Note A2

The information processing device according to Supplementary Note A1, including an analysis means for estimating a relationship between the plurality of applications in the work using the work-related information, in which the tool determination means includes determining a tool relevant to the relationship as a tool available for the work.

### Supplementary Note A3

The information processing device according to Supplementary Note A2, in which the tool determination means determines, in a case where the analysis means estimates that the plurality of applications are in a relationship of exchanging the data in the work, a tool that automates or facilitates at least a part of a work performed by a worker of the work to exchange the data as a tool available for the work.

### Supplementary Note A4

The information processing device according to Supplementary Note A2 or A3, in which the tool determination means determines, in the work, in a case where the analysis means estimates that there is a relationship of using data held or generated by at least another one application in generating a product by one of the plurality of applications, a tool that automates or facilitates at least a part of a work performed by a worker of the work to generate the product as a tool available for the work.

### Supplementary Note A5

The information processing device according to Supplementary Note A1, including an analysis means for estimating a content of the work based on the work-related information, in which the tool determination means determines a tool available for work of the content estimated by the analysis means using tool information indicating a function of each candidate for a recommended tool.

### Supplementary Note A6

The information processing device according to Supplementary Note A1, in which the tool determination means determines a tool relevant to the work-related information using a language model in which a natural language has been machine-learned.

### Supplementary Note A7

The information processing device according to Supplementary Note A6, in which the tool determination means generates, using the work-related information, a prompt instructing to infer a tool capable of making the work efficient, and determines a tool relevant to the work-related information based on an output obtained by inputting the generated prompt into the language model.

### Supplementary Note A8

The information processing device according to any one of Supplementary Notes A1 to A7, in which the work-related information includes at least any of history information indicating a history of operations by a worker who has performed the work, identification information of the application, information indicating a product generated by the work, or information indicating a content of the work.

### Supplementary Note A9

The information processing device according to any one of Supplementary Notes A1 to A8, including a division means for dividing a series of works performed by a worker into a plurality of partial works based on the work-related information, in which the tool determination means determines, for each of the plurality of partial works, a tool available for the partial work.

### Supplementary Note B1

A work support method that causes at least one processor to execute an acquisition process of acquiring work-related information related to a work performed using a plurality of applications, a tool determination process of determining a tool available for the work based on the work-related information, and a presentation control process of presenting the determined tool.

### Supplementary Note B2

The work support method according to Supplementary Note B1, in which the at least one processor executes an analysis process of estimating a relationship between the plurality of applications in the work using the work-related information, and the at least one processor determines a tool relevant to the relationship as a tool available for the work in the tool determination process.

### Supplementary Note B3

The work support method according to Supplementary Note B2, in which in the tool determination process, the at least one processor determines, in a case where it is estimated in the analysis process that the plurality of applications are in a relationship of exchanging the data in the work, a tool that automates or facilitates at least a part of a work performed by a worker of the work to exchange the data as a tool available for the work.

### Supplementary Note B4

The work support method according to Supplementary Note B2 or B3, in which in the tool determination process, the at least one processor determines, in the work, in a case where it is estimated in the analysis process that there is a relationship of using data held or generated by at least another one application for generation of a product by one of the plurality of applications, a tool that automates or facilitates at least a part of a work performed by a worker of the work to generate the product as a tool available for the work.

### Supplementary Note B5

The work support method according to Supplementary Note B1, in which the at least one processor executes an analysis process of estimating a content of the work based on the work-related information, and in the tool determination process, the at least one processor determines a tool available for a work with the content estimated in the analysis process using tool information indicating a function of each candidate for a recommended tool.

### Supplementary Note B6

The work support method according to Supplementary Note B1, in the tool determination process, the at least one processor determines a tool relevant to the work-related information using a language model in which a natural language has been machine-learned.

### Supplementary Note B7

The work support method according to Supplementary Note B6, in which in the tool determination process, the at least one processor generates, using the work-related information, a prompt instructing to infer a tool capable of making the work efficient, and determines a tool relevant to the work-related information based on an output obtained by inputting the generated prompt into the language model.

### Supplementary Note B8

The work support method according to any one of Supplementary Notes B1 to B7, in which the work-related information includes at least any of history information indicating a history of operations by a worker who has performed the work, identification information of the application, information indicating a product generated by the work, or information indicating a content of the work.

### Supplementary Note B9

The work support method according to any one of Supplementary Notes B1 to B8, in which the at least one processor executes a division process of dividing a series of works performed by a worker into a plurality of partial works based on the work-related information, and in the tool determination process, the at least one processor determines, for each of the plurality of partial works, a tool available for the partial work.

### Supplementary Note C1

A work support program causing a computer to function as: an acquisition means for acquiring work-related information related to work performed using a plurality of applications; a tool determination means for determining a tool available for the work based on the work-related information; and a presentation control means for presenting the determined tool.

### Supplementary Note C2

The work support program according to Supplementary Note C1, in which the computer is caused to function as an analysis means for estimating a relationship between the plurality of applications in the work using the work-related information, and the tool determination means includes determining a tool relevant to the relationship as a tool available for the work.

### Supplementary Note C3

The work support program according to Supplementary Note C2, in which the tool determination means determines, in a case where the analysis means estimates that the plurality of applications are in a relationship of exchanging the data in the work, a tool that automates or facilitates at least a part of a work performed by a worker of the work to exchange the data as a tool available for the work.

### Supplementary Note C4

The work support program according to Supplementary Note C2 or C3, in which the tool determination means determines, in the work, in a case where the analysis means estimates that there is a relationship of using data held or generated by at least another one application for generation of a product by one of the plurality of applications, a tool that automates or facilitates at least a part of a work performed by a worker of the work to generate the product as a tool available for the work.

### Supplementary Note C5

The work support program according to Supplementary Note C1, in which the computer is caused to function as an analysis means for estimating a content of the work based on the work-related information, and the tool determination means determines a tool available for work of the content estimated by the analysis means using tool information indicating a function of each candidate for a recommended tool.

### Supplementary Note C6

The work support program according to Supplementary Note C1, in which the tool determination means determines a tool relevant to the work-related information using a language model in which a natural language has been machine-learned.

### Supplementary Note C7

The work support program according to Supplementary Note C6, in which the tool determination means generates, using the work-related information, a prompt instructing to infer a tool capable of making the work efficient, and determines a tool relevant to the work-related information based on an output obtained by inputting the generated prompt into the language model.

### Supplementary Note C8

The work support program according to any one of Supplementary Notes C1 to C7, in which the work-related information includes at least any of history information indicating a history of operations by a worker who has performed the work, identification information of the application, information indicating a product generated by the work, or information indicating a content of the work.

### Supplementary Note C9

The work support program according to any one of Supplementary Notes C1 to C8, in which the computer is caused to function as a division means for dividing a series of works performed by a worker into a plurality of partial works based on the work-related information, in which the tool determination means determines, for each of the plurality of partial works, a tool available for the partial work.

### Supplementary Note D1

An information processing device including at least one processor, in which the at least one processor executes: an acquisition process of acquiring work-related information related to a work performed using a plurality of applications, a tool determination process of determining a tool available for the work based on the work-related information, and a presentation control process of presenting the determined tool.

The information processing device may further include a memory. The memory may store a program for causing the at least one processor to execute each of the processing.

### Supplementary Note D2

The information processing device according to Supplementary Note D1, in which the at least one processor executes an analysis process of estimating a relationship between the plurality of applications in the work using the work-related information, and the at least one processor determines a tool relevant to the relationship as a tool available for the work in the tool determination process.

### Supplementary Note D3

The information processing device according to Supplementary Note D2, in which in the tool determination process, the at least one processor determines, in a case where it is estimated in the analysis process that the plurality of applications are in a relationship of exchanging the data in the work, a tool that automates or facilitates at least a part of a work performed by a worker of the work to exchange the data as a tool available for the work.

### Supplementary Note D4

The information processing device according to Supplementary Note D2 or D3, in which in the tool determination process, the at least one processor determines, in the work, in a case where it is estimated in the analysis process that there is a relationship of using data held or generated by at least another one application for generation of a product by one of the plurality of applications, a tool that automates or facilitates at least a part of a work performed by a worker of the work to generate the product as a tool available for the work.

### Supplementary Note D5

The information processing device according to Supplementary Note D1, in which the at least one processor executes an analysis process of estimating a content of the work based on the work-related information, and in the tool determination process, the at least one processor determines a tool available for a work with the content estimated in the analysis process using tool information indicating a function of each candidate for a recommended tool.

### Supplementary Note D6

The information processing device according to Supplementary Note D1, in the tool determination process, the at least one processor determines a tool relevant to the work-related information using a language model in which a natural language has been machine-learned.

### Supplementary Note D7

The information processing device according to Supplementary Note D6, in the tool determination process, the at least one processor generates, using the work-related information, a prompt instructing to infer a tool capable of making the work efficient, and determines a tool relevant to the work-related information based on an output obtained by inputting the generated prompt into the language model.

### Supplementary Note D8

The information processing device according to any one of Supplementary Notes D1 to D7, in which the work-related information includes at least any of history information indicating a history of operations by a worker who has performed the work, identification information of the application, information indicating a product generated by the work, or information indicating a content of the work.

### Supplementary Note D9

The information processing device according to any one of Supplementary Notes D1 to D8, in which the at least one processor executes a division process of dividing a series of works performed by a worker into a plurality of partial works based on the work-related information, and in the tool determination process, the at least one processor determines, for each of the plurality of partial works, a tool available for the partial work.

### Supplementary Note E)

A non-transitory recording medium storing a work support program for causing a computer to execute: an acquisition process of acquiring work-related information related to a work performed using a plurality of applications; a tool determination process of determining a tool available for the work based on the work-related information; and a presentation control process of presenting the determined tool.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing device comprising:
at least one memory configured to store instructions; and
at least one processor configured to execute the instructions to:
acquire work-related information related to a work performed using a plurality of applications;
determine a tool available for the work based on the work-related information; and
present the determined tool.

2. The information processing device according to claim 1, wherein the least one processor is configured to execute the instructions to:
estimate a relationship between the plurality of applications in the work using the work-related information; and
determine a tool relevant to the relationship as a tool available for the work.

3. The information processing device according to claim 2, wherein the least one processor is configured to execute the instructions to determine, in a case where it is estimated that the plurality of applications have a relationship of exchanging data in the work, a tool that automates or facilitates at least a part of a work performed by a worker of the work for exchanging the data as a tool available for the work.

4. The information processing device according to claim 2, wherein the least one processor is configured to execute the instructions to, in the work, in a case where it is estimated that there is a relationship of using data held or generated by at least another one application for generation of a product by one of the plurality of applications, determine a tool that automates or facilitates at least a part of a work performed by a worker of the work to generate the product as a tool available for the work.

5. The information processing device according to claim 1, wherein the least one processor is configured to execute the instructions to:
estimate a content of the work based on the work-related information; and
determine a tool available for a work of the estimated contents using tool information indicating a function of each candidate for a recommended tool.

6. The information processing device according to claim 1, wherein the least one processor is configured to execute the instructions to determine a tool relevant to the work-related information using a language model in which natural language has been machine-learned.

7. The information processing device according to claim 6, wherein the least one processor is configured to execute the instructions to:
generate, by using the work-related information, a prompt instructing to infer a tool capable of improving efficiency of the work; and
determine a tool relevant to the work-related information based on an output obtained by inputting the generated prompt to the language model.

8. The information processing device according to claim 1, wherein the least one processor is configured to execute the instructions to:
classify a series of works performed by a worker into a plurality of partial works based on the work-related information; and
determine a tool available for the partial work for each of the plurality of partial works.

9. A computer implemented method for work support, comprising:
an acquisition process of acquiring work-related information related to a work performed using a plurality of applications;
a tool determination process of determining a tool available for the work based on the work-related information; and
a presentation control process of presenting the determined tool.

10. The method according to claim 9, comprising an analysis process of estimating a relationship between the plurality of applications in the work using the work-related information,
wherein the tool determination process includes determining a tool relevant to the relationship as a tool available for the work.

11. The method according to claim 10, wherein the tool determination process includes determining, in a case where it is estimated that the plurality of applications are in a relationship of exchanging the data in the work, a tool that automates or facilitates at least a part of a work performed by a worker of the work to exchange the data as a tool available for the work.

12. The method according to claim 10, wherein the tool determination process includes, in the work, in a case where it is estimated that there is a relationship of using data held or generated by at least another one application for generation of a product by one of the plurality of applications, determining a tool that automates or facilitates at least a part of a work performed by a worker of the work to generate the product as a tool available for the work.

13. The method according to claim 9, comprising an analysis process of estimating a content of the work based on the work-related information,
wherein the tool determination process includes determining a tool available for work of the estimated content using tool information indicating a function of each candidate for a recommended tool.

14. The method according to claim 9, wherein the tool determination process includes determining a tool relevant to the work-related information using a language model in which a natural language has been machine-learned.

15. The method according to claim 14, wherein the tool determination process includes:
generating, using the work-related information, a prompt instructing to infer a tool capable of making the work efficient; and
determining a tool relevant to the work-related information based on an output obtained by inputting the generated prompt into the language model.

16. The method according to claim 9, comprising a division process of dividing a series of works performed by a worker into a plurality of partial works based on the work-related information,
wherein the tool determination process determines, for each of the plurality of partial works, a tool available for the partial work.

17. A non-transitory recording medium storing a work support program for causing a computer to execute:
an acquisition process of acquiring work-related information related to a work performed using a plurality of applications;
a tool determination process of determining a tool available for the work based on the work-related information; and
a presentation control process of presenting the determined tool.
